(19) United States
(12) Patent Application Publication
(10) Pub. No.: US 2026/0147153 A1
(43) Pub. Date: May 28, 2026

(54) GLASS SUBSTRATES FOR PHOTONIC INTEGRATED CIRCUITS

(71) Applicant: Lightmatter, Inc., Boston, MA (US)

(72) Inventors: Omkar Karhade, Chandler, AZ (US); Joyce Poon, Toronto (CA); Sandeep Sane, Chandler, AZ (US); Shashank Gupta, Gurugram (IN); Darius Bunandar, Boston, MA (US)

(73) Assignee: Lightmatter, Inc., Boston, MA (US)

(21) Appl. No.: 19/400,902

(22) Filed: Nov. 25, 2025

Related U.S. Application Data
(60) Provisional application No. 63/725,211, filed on Nov. 26, 2024.

(51) Int. Cl. G02B 6/12; G02B 6/136

(52) U.S. Cl. CPC G02B 6/12002; G02B 6/136

(57) ABSTRACT

Described herein are glass substrates that include a cavity and glass fingers extending into the cavity. A photonic integrated circuit (PIC) is positioned near the cavity such that a waveguide of the PIC is optically coupled to a waveguide of the glass substrate formed in one of the glass fingers. The structure described herein allows for improved coupling efficiency between the PIC and the glass substrate, and improved access for underfill and outgassing processes. This approach facilitates reliable packaging of large or multi-reticle PICs while maintaining high optical and mechanical performance.

### CROSS-REFFERENCE TO RELATED APPLICATION

This application claims the benefit of U.S. Provisional Application Ser. No. 63/725,211, filed on Nov. 26, 2024, under Attorney Docket No. L 0858.70106US00 and entitled “PHOTONIC INTEGRATED CIRCUITS PACKAGED WITH GLASS,” which is hereby incorporated herein by reference in its entirety.

### BACKGROUND

Photonic integrated circuits (PICs) are devices that integrate multiple photonic components, such as waveguides, detectors, switches and modulators, on a single substrate. Similar to how electronic integrated circuits manipulate electrical signals, PICs manipulate light to transmit, process and detect information at high speeds and with low power consumption.

PICs are increasingly used in applications such as optical communications, data centers, sensing and quantum computing. Integration of photonic components on a common platform enables compact size, reduced cost, improved performance, and enhanced scalability.

### BRIEF SUMMARY

In some aspects, the techniques described herein relate to a photonic device, including: a glass substrate defining a cavity; a plurality of glass fingers extending from the glass substrate into the cavity; underfill disposed in the cavity between adjacent glass fingers of the plurality of glass fingers; a glass waveguide extending from the glass substrate into a first glass finger of the plurality of glass fingers; and a first photonic integrated circuit (PIC) disposed on the glass substrate near the first glass finger in correspondence with the cavity, wherein the first PIC includes a PIC waveguide optically coupled to the glass waveguide.

In some aspects, the techniques described herein relate to a photonic device, wherein the first PIC is disposed partially inside the cavity of the glass substrate.

In some aspects, the techniques described herein relate to a photonic device, wherein the PIC waveguide of the first PIC is edge coupled to the glass waveguide.

In some aspects, the techniques described herein relate to a photonic device, wherein the first PIC is disposed over the cavity of the glass substrate.

In some aspects, the techniques described herein relate to a photonic device, wherein the PIC waveguide of the first PIC is evanescently coupled to the glass waveguide.

In some aspects, the techniques described herein relate to a photonic device, further including: a second PIC disposed on the glass substrate in correspondence with the cavity; and a glass island in the cavity of the glass substrate, wherein the glass island is disposed between the first PIC and the second PIC.

In some aspects, the techniques described herein relate to a photonic device, wherein the glass island includes a glass waveguide, wherein the glass waveguide of the glass island optically couples to the first PIC to the second PIC.

In some aspects, the techniques described herein relate to a photonic device, further including: a first redistribution layer (RDL) between the first PIC and the glass substrate; and a through glass via (TGV) formed in the glass substrate and electrically coupled to the first RDL.

In some aspects, the techniques described herein relate to a photonic device, further including: a substrate on which the glass substrate is disposed; and a second RDL between the substrate and the glass substrate, wherein the TGV is electrically coupled to the second RDL.

In some aspects, the techniques described herein relate to a photonic device, wherein the first PIC includes a top surface and a back surface, wherein the PIC waveguide is positioned near the top surface of the first PIC, and wherein the photonic device further including an application-specific integrated circuit (ASIC) disposed on the back surface of the first PIC.

In some aspects, the techniques described herein relate to a glass substrate, including: a glass substrate base; a glass frame disposed on the glass substrate base, wherein the glass frame defines a cavity; a plurality of glass fingers extending from the glass frame into the cavity; and a glass waveguide extending from the glass frame into a first glass finger of the plurality of glass fingers.

In some aspects, the techniques described herein relate to a glass substrate, wherein the cavity is between 100 μm and 300 μm in depth.

In some aspects, the techniques described herein relate to a glass substrate, wherein the cavity is between 36 mm² and 882 mm² in area.

In some aspects, the techniques described herein relate to a glass substrate, wherein the glass waveguide is between 3 μm and 6 μm in width.

In some aspects, the techniques described herein relate to a glass substrate, wherein the first glass finger of the plurality of glass fingers is separated from a second glass finger of the plurality of glass fingers by a distance between 1 μm and 100 μm, wherein the first and second glass fingers are adjacent.

In some aspects, the techniques described herein relate to a method for fabricating a photonic device, the method including: obtaining a glass substrate having a plurality of glass waveguides and a photonic integrated circuit (PIC) having a PIC waveguide; etching the glass substrate to define a cavity and a plurality of glass fingers extending from the glass substrate into the cavity, wherein, upon etching the glass substrate, a first glass waveguide of the plurality of glass waveguides extends into a glass finger of the plurality of glass fingers; forming a redistribution layer (RDL) in the cavity of the glass substrate; attaching the PIC to the glass substrate such that the PIC waveguide is optically coupled to the first glass waveguide and the PIC is electrically coupled to the RDL; and forming an underfill in the cavity of the glass substrate between adjacent glass fingers of the plurality of glass fingers.

In some aspects, the techniques described herein relate to a method, wherein etching the glass substrate to define the cavity and the plurality of glass fingers includes etching the glass substrate by an amount between 100 μm and 300 μm.

In some aspects, the techniques described herein relate to a method, further including, prior to attaching the PIC to the glass substrate: testing whether the PIC waveguide is optically coupled to the first glass waveguide; and positioning the PIC on the glass substrate based on the testing.

In some aspects, the techniques described herein relate to a method, wherein forming the underfill in the cavity of the glass substrate includes curing a material having a viscosity between 500 cP and 1500 cP at a temperature between 120° C. and 160° C. for a duration between 30 minutes and 60 minutes.

In some aspects, the techniques described herein relate to a method, wherein attaching the PIC to the glass substrate is performed using thermocompression bonding.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1 is a cross sectional side view of a package including a glass substrate, in accordance with some embodiments.

FIG. 2 is a cross sectional side view of another package including a glass substrate, in accordance with some embodiments.

FIG. 3A is a top view of an example of a glass substrate, in accordance with some embodiments.

FIG. 3B is a top view of an example of a package including the glass substrate of FIG. 3A, in accordance with some embodiments.

FIG. 4 is a flowchart of a method for fabricating a photonic device with a glass substrate, in accordance with some embodiments.

### DETAILED DESCRIPTION

The inventors have recognized and appreciated that packaging photonic integrated circuits (PICs) with glass substrates containing embedded photonic waveguides can provide a low-loss, low-cost, and low-warpage packaging solution. However, the integration of PICs with electronic systems on glass substrates poses a variety of challenges. Conventional coupling techniques between PICs and glass substrates often suffer from high loss and inefficiency, limiting the effectiveness of optical data transmission and resulting in degraded signal performance. Moreover, traditional packaging schemes restrict available area for electrical fan-out routing and obstruct access to under-die regions necessary for fluxing, defluxing and underfilling operations.

To address these challenges, the inventors have developed glass substrates that include a cavity and glass fingers extending into the cavity. A PIC is positioned near the cavity such that a waveguide of the PIC (referred to as “PIC waveguide”) is optically coupled to a waveguide of the glass substrate (referred to herein as “glass substrate”) formed in one of the glass fingers. The structure described herein allows for improved coupling efficiency between the PIC and the glass substrate, and improved access for underfill and outgassing processes. This approach facilitates reliable packaging of large or multi-reticle PICs while maintaining high optical and mechanical performance.

Underfilling is the process by which a protective material (e.g., epoxy or capillary underfill (CUF)) fills the gaps existing between a chip and the underlying substrate. Underfilling serves an important function in semiconductor packages; it provides mechanical stress release. Silicon and organic substrates have different coefficients of thermal expansion (CTE). During thermal cycling, they expand and contract at different rates, causing stress and cracking. The underfill absorbs and redistributes these stresses, greatly improving mechanical stability. The structures described herein enable underfill application in regions of the package that are inaccessible in conventional glass substrates. This improved access is achieved through the formation of a large cavity and glass fingers, as described herein.

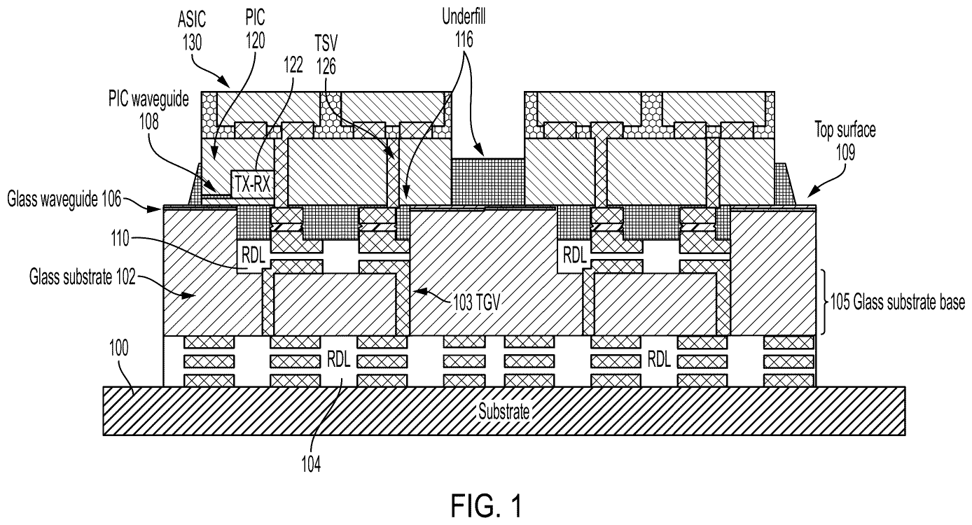

FIG. 1 is a cross sectional side view of a package including a glass substrate arranged in accordance with the techniques described herein. The photonic device of FIG. 1 includes a glass substrate 102 disposed on a substrate 100. Substrate 100 may be a printed circuit board (PCB) or an organic substrate, for example. Substrate 100 is configured to route signals between the photonic device of FIG. 1 and other devices. Glass substrate 102 may be made of any suitable type of glass, including for example SiO₂, fused silica, or borosilicate glass. The glass substrate may be passive in nature in that it may include passive optical devices (e.g., waveguides, passive couplers, waveguide crossings, wavelength multiplexers/demultiplexers, etc.) but may omit active optical devices (e.g., modulators, detectors, switches, etc.). Glass waveguides 106 may be used to route light from one part of glass substrate 102 to another, thereby forming a network optically coupling the PICs to each other. The glass waveguides may be made of any suitable material that is compatible with the technology used to fabricate the glass substrate. The waveguides can be made in-situ within the glass substrate itself with lithography or laser writing. In another embodiment, the waveguides and the passive optical components within the glass substrate can be manufactured using an ion-exchange process. Different glass compositions can necessitate different manufacturing techniques. Further, the waveguides may be made of a material having a refractive index greater than the refractive index of the surrounding material, thus ensuring that the optical mode is sufficiently contained and guided within the waveguide. For example, the glass substrate may be made of SiO₂, and the waveguides may also be made of SiO₂, but doped to produce a larger refractive index, or may be made of silicon nitride. The silicon nitride can either be grown, deposited, or bonded.

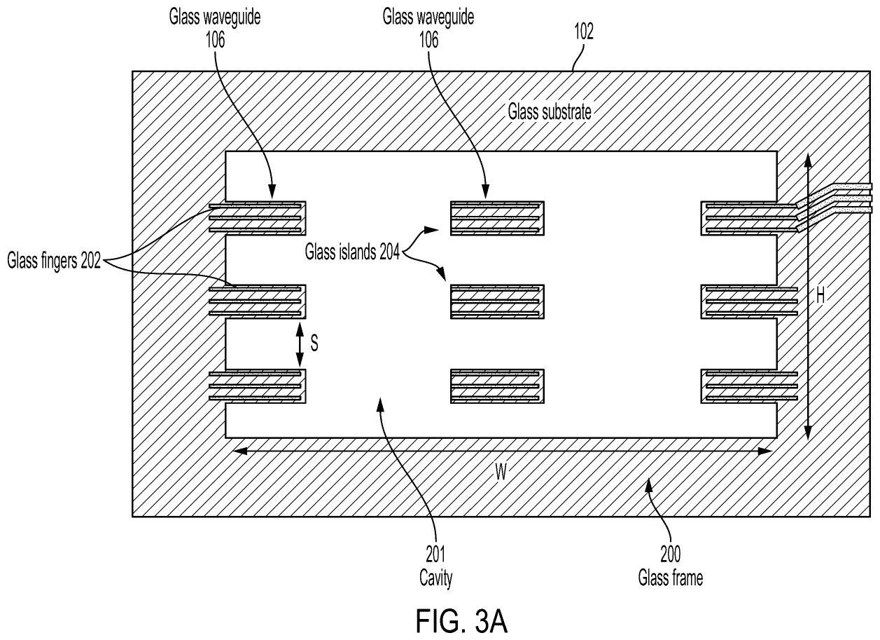

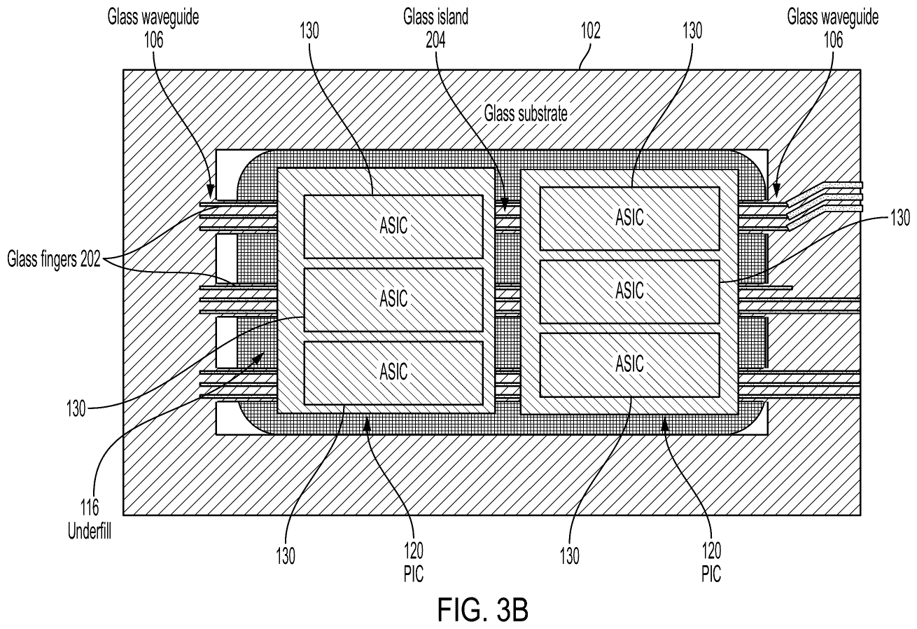

As described in detail further below, glass substrate 102 includes a glass substrate base 105 (labelled in FIG. 1) that extends parallel to the plane of substrate 100. An outer glass frame 200 (labelled in FIG. 3A) is formed on base 105 and extends from base 105 in the vertical direction. Frame 200 is shaped to define a cavity 201 therein.

In some embodiments, the thickness of glass substrate 102 may be less than one inch (e.g., between 150 μm and 350 μm or between 250 μm and 350 μm). In other embodiments, the thickness may be between 1 inch and 20 inches, between 2 inches and 20 inches, between 5 inches and 20 inches, between 7.5 inches and 20 inches, between 10 inches and 20 inches, between 12.5 inches and 20 inches, between 15 inches and 20 inches, between 1 inch and 15 inches, between 2 inches and 15 inches, between 5 inches and 15 inches, between 7.5 inches and 15 inches, between 10 inches and 15 inches, between 12.5 inches and 15 inches, between 1 inch and 10 inches, between 2 inches and 10 inches, between 5 inches and 10 inches, or between 7.5 inches and 10 inches, to provide a few examples.

Multiple photonic integrated circuits (PICs) 120 are disposed on glass substrate 102. In contrast to glass substrate 102, the PICs may be active in nature in that they may include modulators, photodetectors and/or optical switches. In FIG. 1, for example, one of the PICs is depicted as having an optical transceiver (TX-RX) 122. A transceiver includes a transmitter (TX) and a receiver (RX), thus allowing the PIC to handle optical data signals in both incoming and outgoing directions. Further, a PIC may be equipped with optical switches (not shown in FIG. 1) to route data to (and from) any one among the other PICs disposed on the glass substrate. Each PIC may include a network of PIC waveguides. PIC waveguide 108 may extend from TX-RX 122 to the edge of PIC 120. In some embodiments, PICs 120 are made of silicon and implement silicon photonics circuitry.

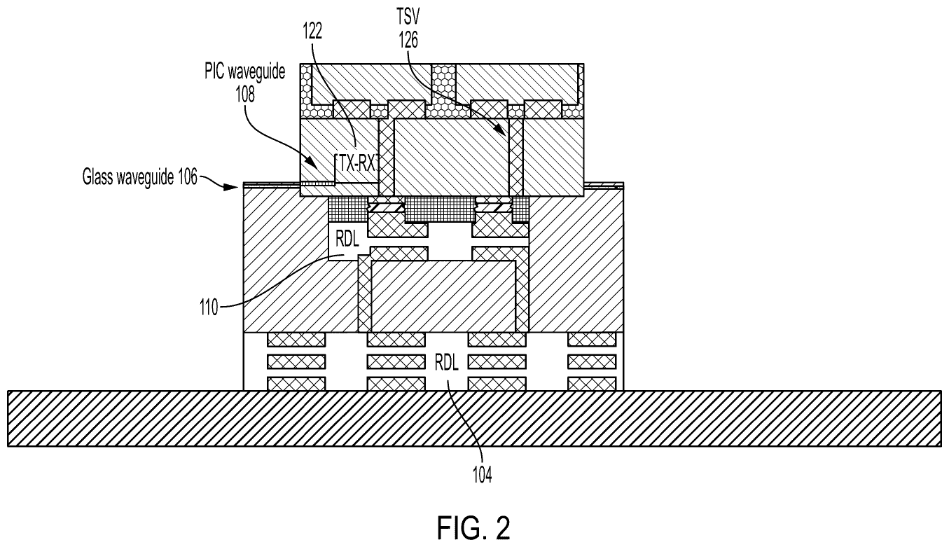

PIC 120 is positioned so that a PIC waveguide 108 is evanescently coupled to a glass waveguide 106. The waveguides are said to be evanescently coupled to one another in that they lie on different planes. Coupling may be achieved using tapers, whereby the optical mode is expanded as it travels closer to the boundary between the PIC and the glass substrate. In other embodiments, PIC 120 is positioned so that a PIC waveguide 108 is edge coupled to a glass waveguide 106. The waveguides are said to be edge coupled to one another in that they lie on the same plane. FIG. 2 illustrates an example of an edge-coupled arrangement. As shown, the end of PIC waveguide 108 and the end of glass waveguide 106 are co-planar.

PIC 120 is disposed in correspondence with a cavity defined in glass substrate 102. For example, PIC 120 may be either disposed over the cavity (as shown in FIG. 1) or partially inside the cavity (as shown in FIG. 2). In the arrangement of FIG. 1, PIC 120 is disposed on the top surface 109 of glass substrate 102. This arrangement results in PIC waveguide 108 lying in a plane that is offset relative to the plane of glass waveguide 106, thus necessitating evanescent coupling. In contrast, in the arrangement of FIG. 2, PIC 120 is disposed so that part of the chip is below the plane defined by the top surface 109 of glass substrate 102. This arrangement results in PIC waveguide 108 lying in the same plane as that of glass waveguide 106, thus enabling edge coupling.

The cavity is filled in part with a redistribution layer (RDL) 110 and in part with an underfill 116. RDL 110 is a layer of metal interconnects configured to reroute signals from PIC 120 to the underlying layers. An additional redistribution layer (RDL 104) is formed between glass substrate 102 and substrate 100. Through glass vias (TGVs) 103 traverse glass substrate 102 in the vertical direction and place RDL 110 in electrical connection with RDL 104. RDL 110, TGVs 103 and RDL 104 permit electrical communication between PIC 120 and substrate 100.

Each PIC supports one or more application-specific integrated circuits (ASICs) 130. In the arrangements of FIGS. 1 and 2, a pair of ASICs is disposed on each PIC, although any other suitable number of ASICs per PIC may be used. Each ASIC may include processing circuitry and/or memory circuitry, for example. The processing circuitry may be implemented as a central processing unit (CPU), a graphic processing unit (GPU), a field programmable gate array (FPGA), an accelerator, etc. The memory circuitry may be implemented as a high-bandwidth memory (HBM), for example. Collectively, the ASICs form a computer system including multiple processing units and multiple memory devices that are optically interconnected with one another.

In the arrangements of FIGS. 1 and 2, PICs 120 are flipped. As such, the top surface of the PICs are placed on the bottom side and the back surfaces are placed on the top side. The top surface of a PIC is defined as the surface through which the photonic circuitry is patterned. As a result, PIC waveguides 108 are formed near the top surface. In contrast, the back surface of a PIC is defined as the surface corresponding to the PIC's supporting substrate. As a result, PIC waveguides 108 are formed distal from the back surface. As further shown in FIGS. 1 and 2, ASICs 130 are disposed on the back surface of PICs 120. Though silicon vias (TSVs) 126 permit electrical communication between the ASICs and the PICS. TSVs 126 traverse PIC 120 in the vertical direction.

Underfill 116 fills the volume between adjacent PICs and the volume between the PICS and RDL 110. Underfill 116 serves an important function; it provides mechanical stress release. PICs 120 and glass substrate 102 have different coefficients of thermal expansion (CTE). During thermal cycling, they expand and contract at different rates, causing stress and cracking. Underfill 116 absorbs and redistributes these stresses, greatly improving mechanical stability. In accordance with aspects of the present disclosure, the glass substrate is shaped to allow underfill 116 to surround the PICS, further improving the mechanical stability of the package. FIGS. 3A-3B illustrate how the glass substrate may be shaped to achieve this effect. FIG. 3A is a top view of an example of a glass substrate, and FIG. 3B is a top view of an example of a package including the glass substrate of FIG. 3A, in accordance with some embodiments.

Referring first to FIG. 3A, glass substrate 102 has a glass frame 200 extending from base 105 in the vertical direction. Glass frame 200 defines a cavity 201 between opposing walls of the frame. A plurality of glass fingers 202 extend from the frame into cavity 201. The glass fingers are separated from each other by gaps that accommodate the underfill material 116 once a PIC 120 is attached. Each glass finger may include one or more glass waveguides 106 that extend towards the cavity region. The waveguides can serve as optical conduits between multiple PICS or between PICs and external optical interfaces.

In some embodiments, the cavity may further contain one or more glass islands 204. Unlike the glass fingers, the glass islands are detached from frame 200. Each glass island 204 may include a glass waveguide configured to optically couple light between adjacent PICs, as shown in FIG. 3B. For example, a first PIC and a second PIC may be positioned on opposite sides of the cavity, and a glass island between them may include a glass waveguide aligned with corresponding PIC waveguides to establish optical communication between the PICs.

The cavity area (width W times height H) may vary depending on the PIC size and the number of PICs to be disposed on the glass substrate. For example, the cavity area may range between 36 mm² and 882mm². An area of 36 mm² is sufficient to accommodate a PIC of 3 mm×3 mm, for example. An area of 882 mm² is sufficient to accommodate two 15 mm×15 mm PICs, for example. The cavity depth may range between 100 μm and 300 μm, providing sufficient space to accommodate RDL 110 and underfill 116. In some embodiments, the separation (S) between adjacent fingers is between 1 μm and 100 μm, between 1 μm and 75 μm, between 1 μm and 50 μm, between 1 μm and 25 μm, between 1 μm and 20 μm, between 1 μm and 10 μm, between 10 μm and 100 μm, between 10 μm and 75 μm, between 10 μm and 50 μm, between 10 μm and 25 μm or between 10 μm and 20 μm, although other ranges are also possible. This provides sufficient separation between the fingers, enabling underfill 116 to fill the gap.

FIG. 3B illustrates the glass substrate of FIG. 3A with a pair of PICs attached to it. In this example, each PIC supports three ASICs. As further shown in FIG. 3B, underfill 116 extends in the volume between adjacent fingers, in the volume between adjacent islands and in the volume between the outer islands and the frame. As a result, underfill 116 surrounds the PICs, further improving the mechanical stability of the package.

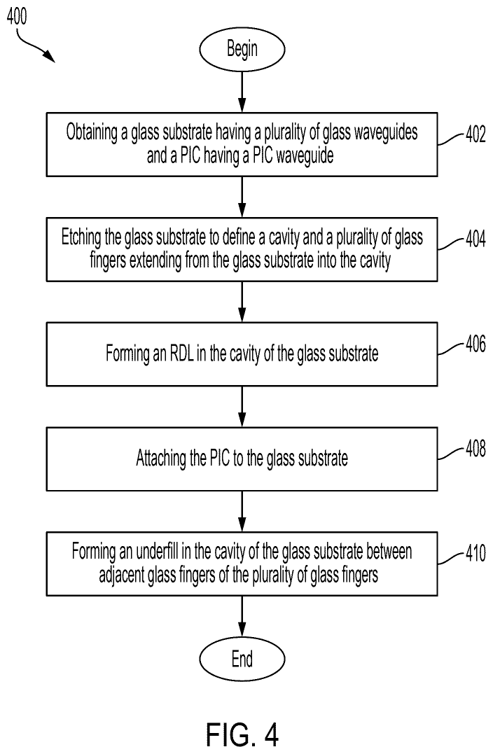

FIG. 4 is a flowchart illustrating a method 400 for fabricating a photonic device, in accordance with some embodiments. The method begins at step 402, in which a glass substrate and one or more PICs are obtained. The glass substrate may include a plurality of glass waveguides patterned thereon. The glass substrate may have been prepared using conventional glass processing techniques, such as ion-exchange to form buried waveguides within the substrate body. The glass waveguides may be between 3 μm and 6 μm in width, thus enabling single-mode operation. The PICs may include PIC waveguides as well as other photonic circuitry, including for example optical switches and transceivers.

At step 404, the glass substrate is etched to define a cavity and a plurality of fingers extending from the substrate into the cavity. Optionally, a plurality of islands are also created through the etching. Upon etching, a first glass waveguide extends into at least one of the glass fingers. The etching may be performed using a variety of techniques depending on the desired cavity profile. In some embodiments, a dry etching process such as a reaction ion etching (RIE) is used to achieve high precision and smooth sidewalls with depths between 100 μm and 200 μm. In other embodiments, wet etching may be used to form cavities having depths between 150 μm and 300 μm. In still other embodiments, laser ablation or laser-assisted etching may be used to define deeper cavities. The choice of process may depend on substrate thickness, target surface roughness and optical alignment requirements. In some embodiments, venting holes may be etched in the cavity to facilitate outgassing during subsequent bonding steps.

Step 406 involves forming a redistribution layer (RDL) in the cavity of the glass substrate. The RDL may be patterned using photolithography and metal deposition techniques such as sputtering, electroplating or chemical vapor deposition. Once the package is assembled and operational, the RDL provides electrical fan-out from the PIC bond pads to the TGVs of the glass substrate. Multiple RDL levels may be used to accommodate complex routing requirements. The RDL patterning may be followed by passivation or planarization steps to prepare a bonding surface for PIC attachment.

At step 408, the one or more PICs are attached to the glass substrate. Once attached, the PIC waveguides are optically coupled to the glass waveguides and the PICs are electrically coupled to the RDL. The attachment process can be implemented using different bonding techniques. In some embodiments, thermocompression bonding is used, applying controlled pressure and temperature (e.g., between 170° C. and 220° C.) to achieve reliable electrical and mechanical connection. In other embodiments, a flip-chip bonding process is used with fluxing and defluxing operations at temperatures between 150° C. and 200° C. The larger cavity and finger configuration provides adequate space for flux flow, outgassing and underfill application. In some embodiments, a thermal adhesive may be used for attachment.

In some embodiments, before final bonding, optical alignment testing may be performed. The alignment between a PIC waveguide and a glass waveguide is verified by injecting light into the PIC and measuring optical power through the glass waveguide using an optical power meter. The PIC position may be adjusted using micro-positioners with sub-micron precision to maximize coupling efficiency. The alignment process may be repeated until the measured coupling efficiency reaches a target threshold (e.g., 90%). Once aligned, the PIC is permanently fixed.

Step 410 involves forming an underfill in the cavity of the glass substrate. This includes forming the underfill in the gaps between adjacent fingers and adjacent islands (where present). The underfill may be dispensed around the perimeter of the PIC and allowed to flow under the PIC by capillary effects. The viscosity of the underfill material may be between 500 cP and 1500 cP. The material may be cured at temperatures between 120° C. and 160° C. for a duration between 30 minutes and 60 minutes. The cured underfill reinforces the mechanical integrity of the package, distributes stress and improves thermal management during device operation.

The resulting structure provides robust optical coupling and electrical integration within a compact package. The presence of the cavity and glass fingers ensures access to under-PIC regions for processing and allows for larger fan-out routing.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. A photonic device, comprising:
a glass substrate defining a cavity;
a plurality of glass fingers extending from the glass substrate into the cavity;
underfill disposed in the cavity between adjacent glass fingers of the plurality of glass fingers;
a glass waveguide extending from the glass substrate into a first glass finger of the plurality of glass fingers; and
a first photonic integrated circuit (PIC) disposed on the glass substrate near the first glass finger in correspondence with the cavity, wherein the first PIC comprises a PIC waveguide optically coupled to the glass waveguide.

2. The photonic device of claim 1, wherein the first PIC is disposed partially inside the cavity of the glass substrate.

3. The photonic device of claim 2, wherein the PIC waveguide of the first PIC is edge coupled to the glass waveguide.

4. The photonic device of claim 1, wherein the first PIC is disposed over the cavity of the glass substrate.

5. The photonic device of claim 4, wherein the PIC waveguide of the first PIC is evanescently coupled to the glass waveguide.

6. The photonic device of claim 1, further comprising:
a second PIC disposed on the glass substrate in correspondence with the cavity; and
a glass island in the cavity of the glass substrate, wherein the glass island is disposed between the first PIC and the second PIC.

7. The photonic device of claim 6, wherein the glass island comprises a glass waveguide, wherein the glass waveguide of the glass island optically couples to the first PIC to the second PIC.

8. The photonic device of claim 1, further comprising:
a first redistribution layer (RDL) between the first PIC and the glass substrate; and
a through glass via (TGV) formed in the glass substrate and electrically coupled to the first RDL.

9. The photonic device of claim 8, further comprising:
a substrate on which the glass substrate is disposed; and
a second RDL between the substrate and the glass substrate, wherein the TGV is electrically coupled to the second RDL.

10. The photonic device of claim 1, wherein the first PIC comprises a top surface and a back surface, wherein the PIC waveguide is positioned near the top surface of the first PIC, and wherein the photonic device further comprising an application-specific integrated circuit (ASIC) disposed on the back surface of the first PIC.

11. A glass substrate, comprising:
a glass substrate base;
a glass frame disposed on the glass substrate base, wherein the glass frame defines a cavity;
a plurality of glass fingers extending from the glass frame into the cavity; and
a glass waveguide extending from the glass frame into a first glass finger of the plurality of glass fingers.

12. The glass substrate of claim 11, wherein the cavity is between 100 μm and 300 μm in depth.

13. The glass substrate of claim 11, wherein the cavity is between 36 mm² and 882 mm² in area.

14. The glass substrate of claim 11, wherein the glass waveguide is between 3 μm and 6 μm in width.

15. The glass substrate of claim 11, wherein the first glass finger of the plurality of glass fingers is separated from a second glass finger of the plurality of glass fingers by a distance between 1 μm and 100 μm, wherein the first and second glass fingers are adjacent.

16. A method for fabricating a photonic device, the method comprising:
obtaining a glass substrate having a plurality of glass waveguides and a photonic integrated circuit (PIC) having a PIC waveguide;
etching the glass substrate to define a cavity and a plurality of glass fingers extending from the glass substrate into the cavity, wherein, upon etching the glass substrate, a first glass waveguide of the plurality of glass waveguides extends into a glass finger of the plurality of glass fingers;
forming a redistribution layer (RDL) in the cavity of the glass substrate;
attaching the PIC to the glass substrate such that the PIC waveguide is optically coupled to the first glass waveguide and the PIC is electrically coupled to the RDL; and
forming an underfill in the cavity of the glass substrate between adjacent glass fingers of the plurality of glass fingers.

17. The method of claim 16, wherein etching the glass substrate to define the cavity and the plurality of glass fingers comprises etching the glass substrate by a depth between 100 μm and 300 μm.

18. The method of claim 16, further comprising, prior to attaching the PIC to the glass substrate:
testing whether the PIC waveguide is optically coupled to the first glass waveguide; and
positioning the PIC on the glass substrate based on the testing.

19. The method of claim 16, wherein forming the underfill in the cavity of the glass substrate comprises curing a material having a viscosity between 500 cP and 1500 cP at a temperature between 120° C. and 160° C. for a duration between 30 minutes and 60 minutes.

20. The method of claim 16, wherein attaching the PIC to the glass substrate is performed using thermocompression bonding.
